(19) United States
(12) Patent Application Publication
(10) Pub. No.: US 2024/0142232 A1
(43) Pub. Date: May 2, 2024

(54) Electronic Component, Sensor Module, And Method For Manufacturing Electronic Component

(71) Applicant: SEIKO EPSON CORPORATION, Tokyo (JP)

(72) Inventor: Manabu KONDO, Matsumoto (JP)

(21) Appl. No.: 18/493,842

(22) Filed: Oct. 25, 2023

(30) Foreign Application Priority Data
Oct. 26, 2022 (JP) 2022-171237
Nov. 10, 2022 (JP) 2022-180119

(51) Int. Cl. G01C 19/00

(52) U.S. Cl. CPC G01C 19/005

(57) ABSTRACT

An electronic component includes: a substrate including a flexible wiring board having a first surface and a second surface that are in a front and back relationship, and a support plate having a first opening and joined to the first surface of the flexible wiring board; and a first component and a second component both disposed on the substrate. The substrate includes a first region in which the first surface extends along a first direction and a second direction orthogonal to each other, a second region that is disposed on one side of the first region in the first direction and in which the first surface extends along a third direction orthogonal to the first direction and the second direction, and a first coupling region that is located between the first region and the second region and is bent such that a support plate side is located inside. The first component is attached to the first surface in the first region via the first opening. The second component is attached to the second region.

The present application is based on, and claims priority from JP Application Serial Number 2022-171237, filed on Oct. 26, 2022 and JP Application Serial Number 2022-180119, filed on Nov. 10, 2022, the disclosure of which is hereby incorporated by reference herein in its entirety.

### BACKGROUND

### 1. Technical Field

The present disclosure relates to an electronic component, a sensor module, and a method for manufacturing an electronic component.

### 2. Related Art

JP-A-2014-105997 discloses an electronic component including a flexible wiring board, a first substrate located along a first surface of the flexible wiring board, a circuit chip located on a surface side opposite from the first surface of the flexible wiring board, and a second substrate having a recess on which the flexible wiring board is placed, in which the flexible wiring board is bent such that a circuit chip side is located inside.

However, in the electronic component disclosed in JP-A-2014-105997, a terminal of the circuit chip and a wiring of the flexible wiring board, and the wiring of the flexible wiring board and a terminal of the second substrate are electrically coupled by bonding wires, and thus when vibration or impact is applied, disconnection of the bonding wire may occur, resulting in a problem in reliability of electrical coupling.

### SUMMARY

An electronic component includes: a substrate including a flexible wiring board having a first surface and a second surface that are in a front and back relationship, and a support plate having a first opening and joined to the first surface of the flexible wiring board; and a first component and a second component both disposed on the substrate. The substrate includes a first region in which the first surface extends along a first direction and a second direction orthogonal to each other, a second region that is disposed on one side of the first region in the first direction and in which the first surface extends along a third direction orthogonal to the first direction and the second direction, and a first coupling region that is located between the first region and the second region and is bent such that a support plate side is located inside. The first component is attached to the first surface in the first region via the first opening. The second component is attached to the second region.

A sensor module includes: a substrate including a flexible wiring board having a first surface and a second surface that are in a front and back relationship, and a support plate having a first opening and joined to the first surface of the flexible wiring board; and a first sensor device and a second sensor device both disposed on the substrate. When three axes orthogonal to one another are referred to as an X axis, a Y axis, and a Z axis, the first sensor device includes a first sensor element and a first package that accommodates the first sensor element and has a surface along the X axis and the Y axis and a thickness along the Z axis, and a direction of the thickness of the first package intersects a mounting surface of the first package attached to the substrate, and the second sensor device includes a second sensor element and a second package that accommodates the second sensor element and has a surface along the Y axis and the Z axis and a thickness along the X axis, and a direction of the thickness of the second package intersects a mounting surface of the second package attached to the substrate. The substrate includes a first region in which the first surface extends along a first direction and a second direction orthogonal to each other, a second region that is disposed on one side of the first region in the first direction and in which the first surface extends along a third direction orthogonal to the first direction and the second direction, and a first coupling region that is located between the first region and the second region and is bent such that a support plate side is located inside. The first sensor device is attached to the first surface in the first region via the first opening. The second sensor device is attached to the second region.

A method for manufacturing an electronic component includes a component attaching step of preparing a flexible wiring board having a first surface and a second surface that are in a front and back relationship, a first component, and a second component, attaching the first component to the first surface of the flexible wiring board, and attaching the second component to the first surface or the second surface; a substrate forming step of preparing a support plate having a first opening, and forming a substrate by joining the support plate to the first surface of the flexible wiring board such that the first component is disposed in the first opening; and a bending step of bending the substrate such that a support plate side of a first coupling region between a first region including the first component and a second region including the second component is to be inside.

### BRIEF DESCRIPTION OF THE DRAWINGS

FIG. 1 is a perspective view showing a configuration of an electronic component according to a first embodiment.

FIG. 2 is a perspective view showing the configuration of the electronic component according to the first embodiment.

FIG. 3 is a perspective view showing a configuration of a sensor unit provided in the electronic component according to the first embodiment.

FIG. 4 is a side view showing the configuration of the sensor unit provided in the electronic component according to the first embodiment.

FIG. 5 is a perspective view showing the configuration of the sensor unit provided in the electronic component according to the first embodiment.

FIG. 6 is a flowchart showing a method for manufacturing the electronic component according to the first embodiment.

FIG. 7 is a perspective view showing the method for manufacturing the electronic component.

FIG. 8 is a perspective view showing the method for manufacturing the electronic component.

FIG. 9 is a perspective view showing the method for manufacturing the electronic component.

FIG. 10 is a perspective view showing the method for manufacturing the electronic component.

FIG. 11 is a perspective view showing the method for manufacturing the electronic component.

FIG. 12 is a flowchart showing a method for manufacturing an electronic component according to a first modification.

FIG. 13 is a perspective view showing the modification of the method for manufacturing the electronic component.

FIG. 14 is a plan view showing a modification of the method for manufacturing the electronic component.

FIG. 15 is a perspective view showing a configuration of a sensor unit provided in an electronic component according to a second embodiment.

### DESCRIPTION OF EMBODIMENTS

### 1. First Embodiment

### 1.1. Electronic Component

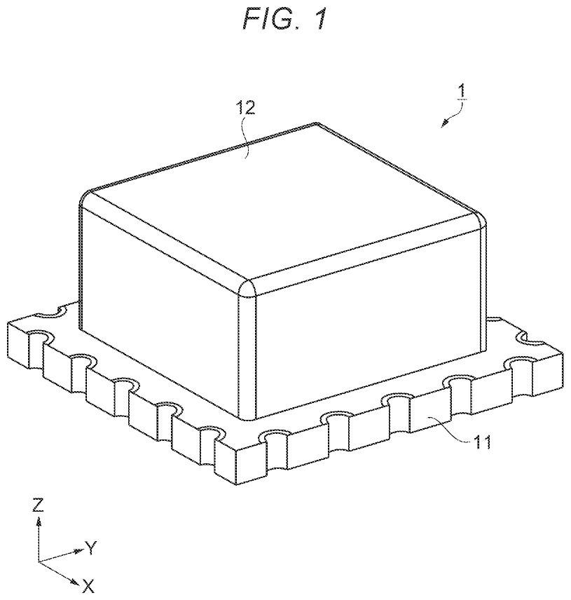

First, a sensor module 1 including a three-axis gyro sensor as an electronic component according to a first embodiment will be described as an example with reference to FIGS. 1 to 5.

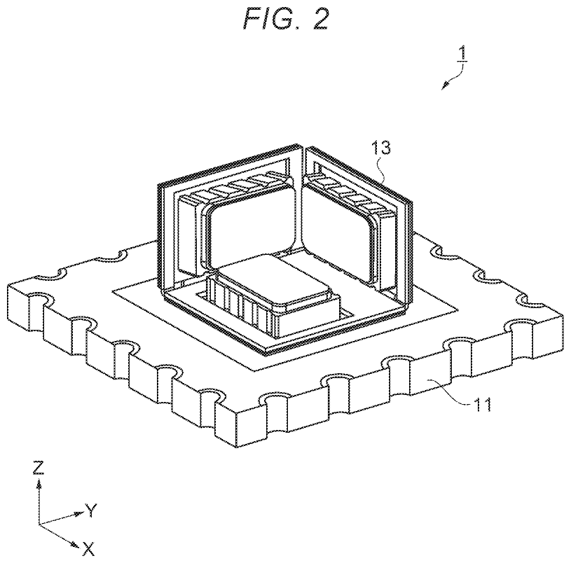

FIG. 2 shows a state in which a case 12 is removed for convenience of describing an internal configuration of the sensor module 1. In FIGS. 1 to 5 and 15, an X axis, a Y axis, and a Z axis are shown as three axes orthogonal to one another for convenience of description. A direction along the X axis is referred to as an “X direction”, a direction along the Y axis is referred to as a “Y direction”, and a direction along the Z axis is referred to as a “Z direction”. An arrow side of each axis is also referred to as a “plus side”, and an opposite side from the arrow is also referred to as a “minus side”. A Z direction plus side is also referred to as “upper”, and a Z direction minus side is also referred to as “lower”.

The sensor module 1 according to the embodiment is a three-axis gyro sensor that detects angular velocities around the X axis, the Y axis, and the Z axis orthogonal to one another, and includes a base substrate 11, the case 12 that accommodates a sensor unit 13 that detects the angular velocities around the three axes, and the sensor unit 13 as shown in FIGS. 1 and 2.

The base substrate 11 is a rectangular flat plate, a plurality of terminals are provided on an upper surface that is a flat surface on a case 12 side, and the sensor unit 13 that detects the angular velocities around the X axis, the Y axis, and the Z axis orthogonal to one another is mounted via solder or the like. A plurality of external terminals are provided on a lower surface.

The case 12 has a recess that opens toward the base substrate 11, and accommodates the sensor unit 13 in the recess. The case 12 is joined to the base substrate 11 via a joining material such as an adhesive.

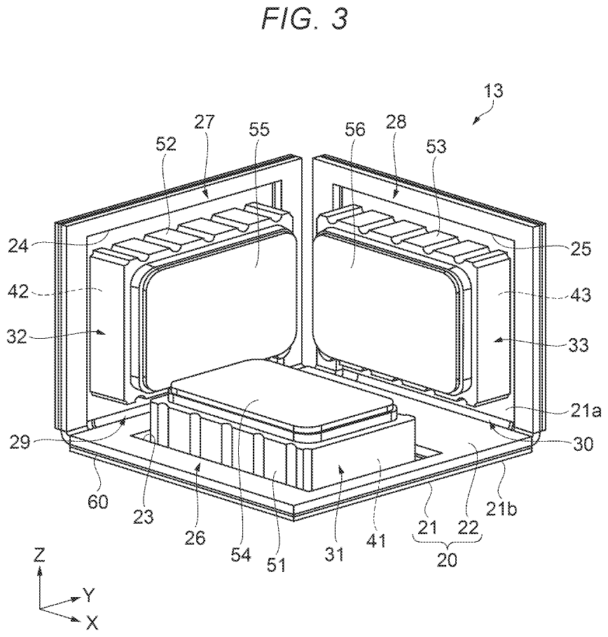

As shown in FIG. 3, the sensor unit 13 includes a substrate 20, a first sensor device 31 as a first component, a second sensor device 32 as a second component, and a third sensor device 33 as a third component which are disposed on the substrate 20.

The substrate 20 includes a flexible wiring board 21 having a first surface 21a and a second surface 21b that are in a front and back relationship, and a support plate 22 having a first opening 23, a second opening 24, and a third opening 25 and joined to the first surface 21a of the flexible wiring board 21 via an adhesive 60.

The substrate 20 includes a first region 26 in which the first surface 21a extends along the X direction as a first direction and the Y direction as a second direction orthogonal to each other, a second region 27 that is disposed on an X direction minus side which is one side of the first region 26 in the X direction and in which the first surface 21a extends along the Z direction as a third direction orthogonal to the X direction and the Y direction, a third region 28 that is disposed on a Y direction plus side which is one side of the first region 26 in the Y direction and in which the first surface 21a extends along the Z direction, a first coupling region 29 that is located between the first region 26 and the second region 27 and is bent such that a support plate 22 side is located inside, and a second coupling region 30 that is located between the first region 26 and the third region 28 and is bent such that a support plate 22 side is located inside.

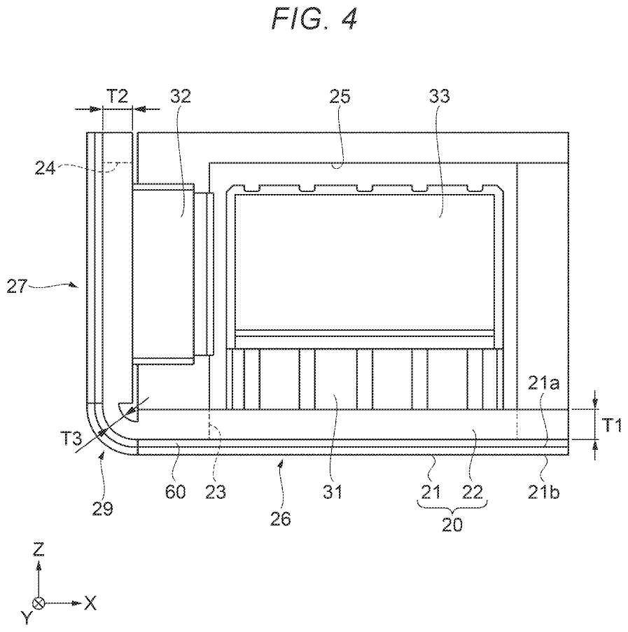

As shown in FIG. 4, a thickness T3 of the support plate 22 in the first coupling region 29 is smaller than thicknesses T1 and T2 of the support plate 22 in the first region 26 and the second region 27. Therefore, the support plate 22 is easily bent in the first coupling region 29. Similarly, a thickness of the support plate 22 in the second coupling region 30 is smaller than a thickness of the support plate 22 in other regions so as to facilitate a bending process.

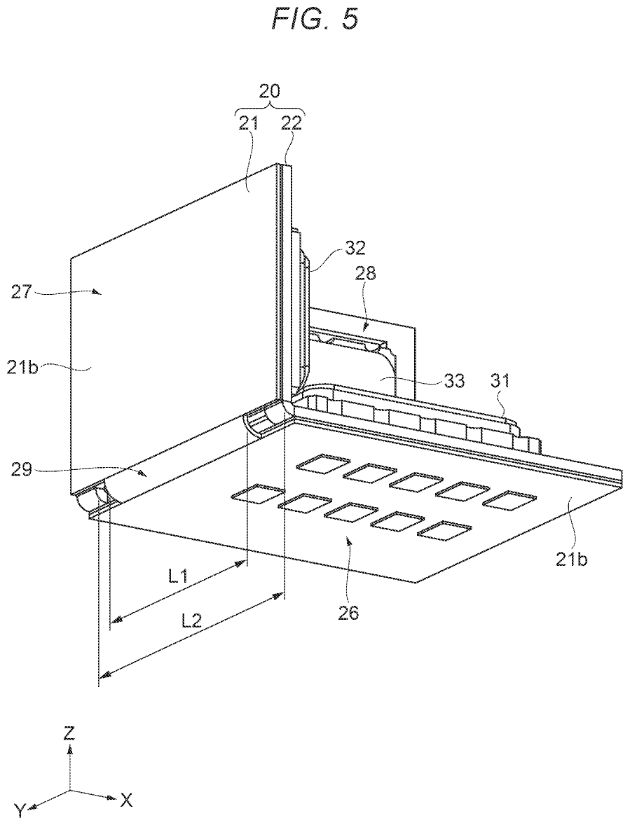

In the support plate 22, as shown in FIGS. 4 and 5, the second opening 24 in the second region 27 is formed from the second region 27 to the first coupling region 29, and a length L1 along the Y direction of the flexible wiring board 21 in the first coupling region 29 is within a range of a length L2 along the Y direction of the second opening 24 in the first coupling region 29. Therefore, the flexible wiring board 21 is not provided in a bent portion of the support plate 22, and the flexible wiring board 21 can be gently bent in the second opening 24, whereby distortion of the flexible wiring board 21 can be reduced. Similarly, in order to reduce the distortion of the flexible wiring board 21, the third opening 25 in the third region 28 is formed from the third region 28 to the second coupling region 30, and a length along the X direction of the flexible wiring board 21 in the second coupling region 30 is within a range of a length along the X direction of the third opening 25 in the second coupling region 30.

The first surface 21a of the flexible wiring board 21 is provided with a wiring for electrically coupling to the sensor devices 31, 32, and 33, and the second surface 21b of the flexible wiring board 21 is provided with a wiring electrically coupled to the wiring provided on the first surface 21a via a through wiring or the like. The wiring provided on the second surface 21b is electrically coupled to the terminal provided on the upper surface of the base substrate 11 via a conductive joining material.

The first sensor device 31 is a gyro sensor that detects an angular velocity around the Z axis. The first sensor device 31 includes a first sensor element 41, a first package 51 that accommodates the first sensor element 41 and has a surface along the X axis and the Y axis and a thickness along the Z axis, and a lid 54 that seals the first package 51 accommodating the first sensor element 41. The first sensor device 31 is attached to the first region 26.

More specifically, the first sensor device 31 is attached to the first surface 21a in the first region 26 via the first opening 23. A thickness direction of the first package 51 intersects a mounting surface of the first package 51 attached to the substrate 20.

The second sensor device 32 is a gyro sensor that detects an angular velocity around the X axis. The second sensor device 32 includes a second sensor element 42, a second package 52 that accommodates the second sensor element 42 and has a surface along the Y axis and the Z axis and a thickness along the X axis, and a lid 55 that seals the second package 52 accommodating the second sensor element 42. The second sensor device 32 is attached to the second region 27.

More specifically, the second sensor device 32 is attached to the first surface 21a in the second region 27 via the second opening 24. A thickness direction of the second package 52 intersects a mounting surface of the second package 52 attached to the substrate 20.

The third sensor device 33 is a gyro sensor that detects an angular velocity around the Y axis. The third sensor device 33 includes a third sensor element 43, a third package 53 that accommodates the third sensor element 43 and has a surface along the X axis and the Z axis and a thickness along the Y axis, and a lid 56 that seals the third package 53 accommodating the third sensor element 43. The third sensor device 33 is attached to the third region 28.

More specifically, the third sensor device 33 is attached to the first surface 21a in the third region 28 via the third opening 25. A thickness direction of the third package 53 intersects a mounting surface of the third package 53 attached to the substrate 20.

Each of the first sensor device 31, the second sensor device 32, and the third sensor device 33 includes a mounting surface attached to the first surface 21a, a lid surface on an opposite side from the mounting surface, side surfaces coupling the mounting surface and the lid surface, and a terminal disposed from the mounting surface to the side surfaces. The terminals are electrically coupled to the wiring provided on the first surface 21a of the flexible wiring board 21 via a conductive joining material. Therefore, it is not necessary to perform electrical coupling by a bonding wire, and reliability of the electrical coupling can be improved even when vibration or impact is applied.

As described above, in the sensor module 1 as the electronic component according to the embodiment, the sensor devices 31, 32, and 33 are electrically coupled to the wiring on the flexible wiring board 21 via the conductive joining material. The sensor unit 13 is electrically coupled to the base substrate 11 via a conductive joining material. Therefore, the bonding wire is not used in each electrical coupling, so that there is no possibility of disconnection of the bonding wire when vibration or impact is applied, and reliability of the electrical coupling can be improved. Therefore, the sensor module 1 having high reliability of electrical coupling can be obtained.

### 1.2. Method for Manufacturing Electronic Component

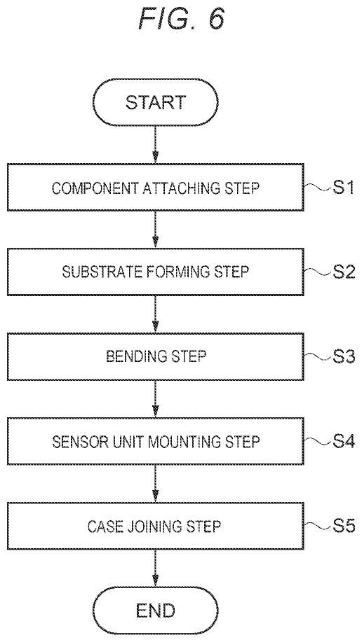

Next, a method for manufacturing the sensor module 1 as the electronic component according to the first embodiment will be described with reference to FIGS. 6 to 11.

As shown in FIG. 6, the method for manufacturing the sensor module 1 according to the embodiment includes a component attaching step, a substrate forming step, a bending step, a sensor unit mounting step, and a case joining step.

### 1.2.1. Component Attaching Step

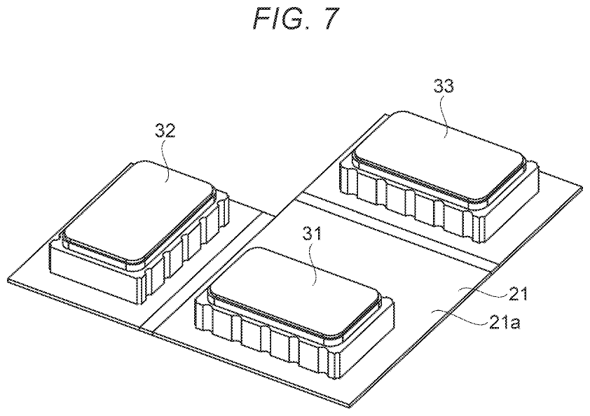

First, in step S1, the flexible wiring board 21 having the first surface 21a and the second surface 21b that are in a front and back relationship, the first sensor device 31 as a first component, the second sensor device 32 as a second component, and the third sensor device 33 as a third component are prepared. Next, as shown in FIG. 7, the first sensor device 31, the second sensor device 32, and the third sensor device 33 are attached to a wiring provided on the first surface 21a of the flexible wiring board 21 via a conductive joining material.

### 1.2.2. Substrate Forming Step

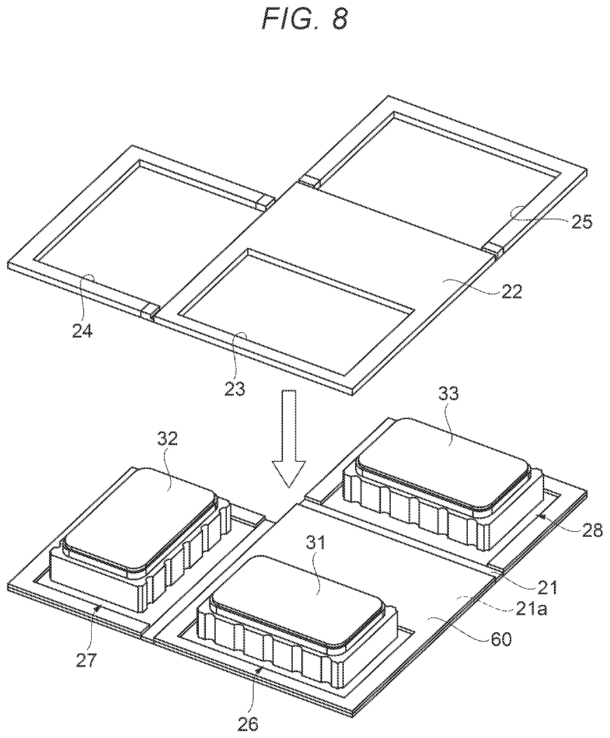

In step S2, the support plate 22 having the first opening 23 in the first region 26, the second opening 24 in the second region 27, and the third opening 25 in the third region 28 is prepared. Next, as shown in FIG. 8, the substrate 20 is formed by joining the support plate 22 to the first surface 21a of the flexible wiring board 21 via the adhesive 60 such that the first sensor device 31 is disposed in the first opening 23, the second sensor device 32 is disposed in the second opening 24, and the third sensor device 33 is disposed in the third opening 25.

### 1.2.3. Bending Step

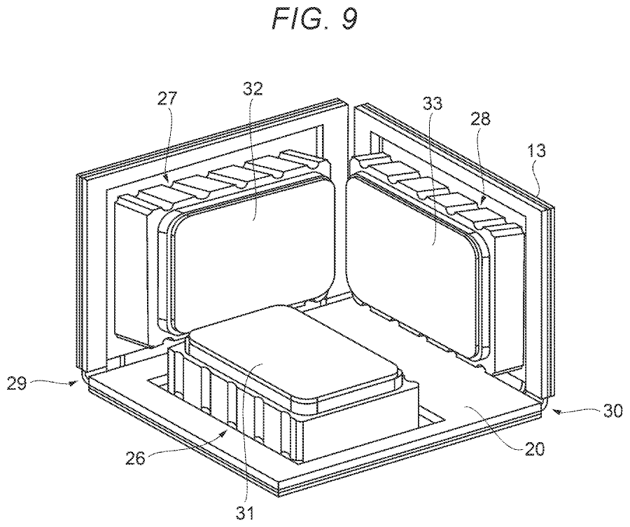

In step S3, as shown in FIG. 9, first, the substrate 20 is bent such that the support plate 22 side of the first coupling region 29 between the first region 26 including the first sensor device 31 and the second region 27 including the second sensor device 32 is to be inside. More specifically, the substrate 20 is bent such that the first surface 21a in the second region 27 is along the Z direction. Next, the substrate 20 is bent such that the support plate 22 side of the second coupling region 30 between the first region 26 including the first sensor device 31 and the third region 28 including the third sensor device 33 is to be inside. More specifically, the substrate 20 is bent such that the first surface 21a in the third region 28 is along the Z direction.

### 1.2.4. Sensor Unit Mounting Step

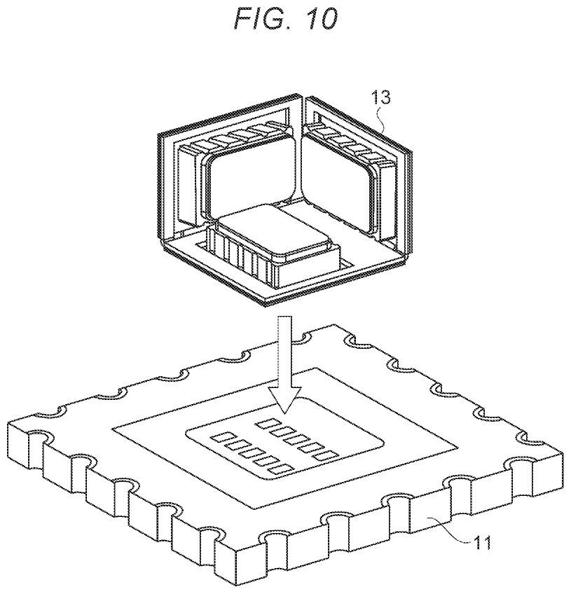

In step S4, the base substrate 11 is prepared, and as shown in FIG. 10, the sensor unit 13 is disposed on an upper surface of the base substrate 11, and the base substrate 11 and the sensor unit 13 are joined by a conductive joining material. More specifically, the terminal provided on the base substrate 11 is electrically coupled to a wiring provided on the second surface 21b of the flexible wiring board 21 of the sensor unit 13 by a conductive joining material.

### 1.2.5. Case Joining Step

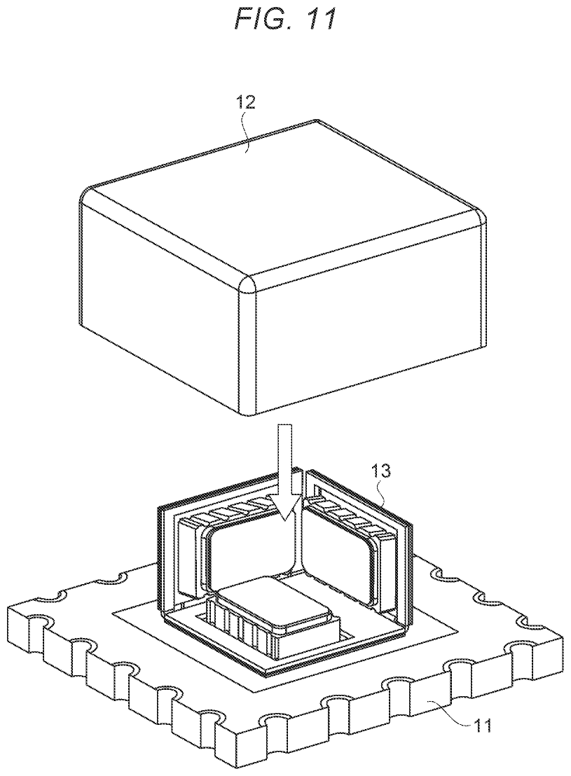

In step S5, the case 12 is prepared, and as shown in FIG. 11, the case 12 is disposed to cover the sensor unit 13 mounted on the base substrate 11, and the case 12 is joined to the base substrate 11 by a joining material.

Through the above steps, the sensor module 1 is completed.

In the embodiment, the substrate forming step is performed after the component attaching step, but the present disclosure is not limited thereto, and the component attaching step may be performed after the substrate forming step.

As described above, in the method for manufacturing the sensor module 1 as the electronic component according to the embodiment, in the component attaching step, the conductive joining material is interposed for electrical coupling between each of the sensor devices 31, 32, and 33 and the wiring on the flexible wiring board 21. In the sensor unit mounting step, the sensor unit 13 is electrically coupled to the base substrate 11 via the conductive joining material. Therefore, the bonding wire is not used in each electrical coupling, so that there is no possibility of disconnection of the bonding wire when vibration or impact is applied, and reliability of the electrical coupling can be improved. Therefore, the sensor module 1 having high reliability of electrical coupling can be manufactured.

### 1.3.1. First Modification of Method for Manufacturing Electronic Component

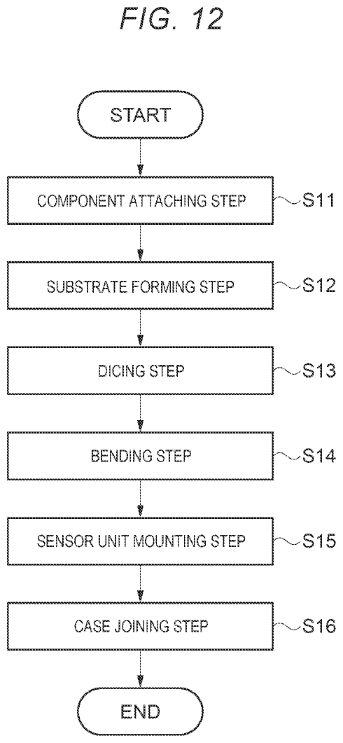

Next, a first modification of the method for manufacturing the sensor module 1 as the electronic component will be described with reference to FIGS. 12 and 13.

As shown in FIG. 12, the method for manufacturing the sensor module 1 according to the first modification includes a component attaching step, a substrate forming step, a dicing step, a bending step, a sensor unit mounting step, and a case joining step.

First, in the component attaching step that is step S11, a rectangular flexible wiring board 61 that couples regions constituting a plurality of first sensor devices 31, second sensor devices 32, and third sensor devices 33, and the plurality of first sensor devices 31, second sensor devices 32, and third sensor devices 33 are prepared, and the sensor devices 31, 32, and 33 are mounted on the flexible wiring board 61.

Next, in the substrate forming step that is step S12, a plurality of support plates 22 are prepared, and as shown in FIG. 13, the plurality of support plates 22 are disposed on and bonded to the flexible wiring board 61.

Next, in the dicing step that is step S13, the flexible wiring board 61 is cut and diced into the substrates 20 to each of which the support plate 22 is bonded.

Next, in the bending step that is step S14, the first coupling region 29 and the second coupling region 30 are bent such that the support plate 22 side is located inside, and the sensor unit 13 is completed.

According to such a manufacturing method, a plurality of substrates 20 can be manufactured collectively, and a manufacturing cost can be reduced.

### 1.3.2. Second Modification of Method for Manufacturing Electronic Component

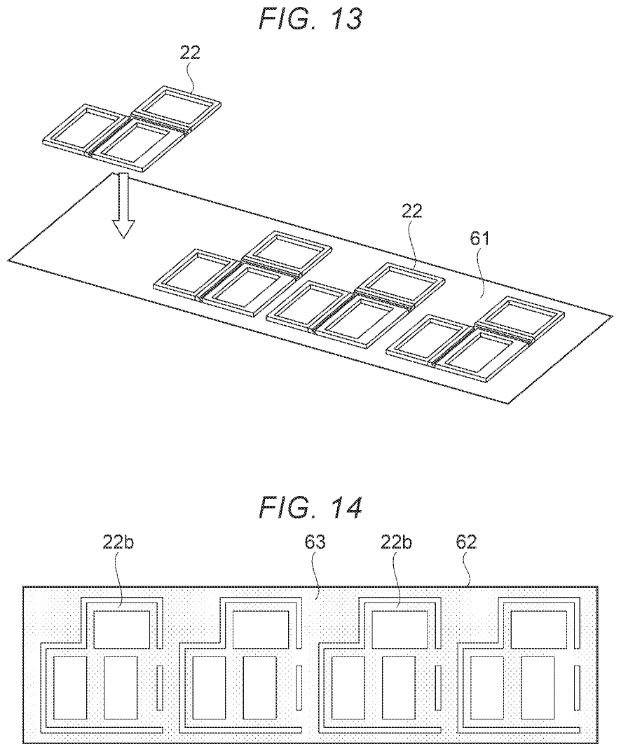

Next, a second modification of the method for manufacturing the electronic component will be described with reference to FIG. 14.

A manufacturing process of the second modification is the same as a manufacturing process of the first modification. In the substrate forming step that is step S12, as shown in FIG. 14, a support plate substrate 62 in which the plurality of support plates 22b are formed via a frame portion 63 is prepared, and only the support plates 22b in the support plate substrate 62 are bonded to the rectangular flexible wiring board 61. Then, in the dicing step that is step S13, the frame portion 63 is removed and the flexible wiring board 61 is cut, whereby the flexible wiring board 61 is diced into the substrates 20 to each of which the support plate 22b is bonded. Thereafter, in the bending step that is step S14, the first coupling region 29 and the second coupling region 30 are bent such that a support plate 22b side is located inside, and the sensor unit 13 is completed.

According to such a manufacturing method, the number of steps of bonding the support plates 22b to the flexible wiring board 61 is reduced, and a plurality of substrates 20 can be collectively manufactured as in the first modification, thereby further reducing a manufacturing cost.

### 2. Second Embodiment

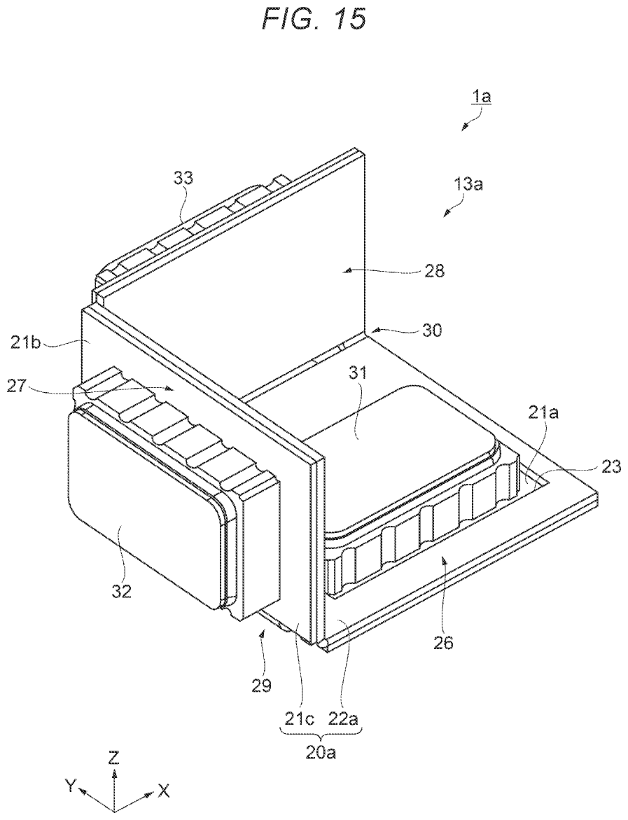

Next, a sensor module 1a as an electronic component according to a second embodiment will be described with reference to FIG. 15.

FIG. 15 only shows a sensor unit 13a for convenience of describing an internal configuration of the sensor module 1a.

The sensor module 1a according to the embodiment is the same as the sensor module 1 according to the first embodiment except that a structure of the sensor unit 13a is different from that of the sensor module 1 according to the first embodiment. The difference from the first embodiment described above will be mainly described, the same matters are denoted by the same reference numerals, and description thereof will be omitted.

The sensor module 1a according to the embodiment includes the base substrate 11 (not shown), the case 12 (not shown) that accommodates the sensor unit 13a that detects angular velocities around three axes, and the sensor unit 13a.

As shown in FIG. 15, the sensor unit 13a includes a substrate 20a, the first sensor device 31 as a first component, the second sensor device 32 as a second component, and the third sensor device 33 as a third component which are disposed on the substrate 20a.

The substrate 20a includes a flexible wiring board 21c having the first surface 21a and the second surface 21b that are in a front and back relationship, and a support plate 22a having the first opening 23 and joined to the first surface 21a of the flexible wiring board 21c.

The first sensor device 31 is a gyro sensor that detects an angular velocity around the Z axis, and is attached to the first region 26. More specifically, the first sensor device 31 is attached to the first surface 21a in the first region 26 via the first opening 23.

The second sensor device 32 is a gyro sensor that detects an angular velocity around the X axis, and is attached to the second surface 21b in the second region 27.

The third sensor device 33 is a gyro sensor that detects an angular velocity around the Y axis, and is attached to the second surface 21b in the third region 28.

With this configuration, the same effects as those attained in the first embodiment can be attained.

What is claimed is:

1. An electronic component comprising:
a substrate including a flexible wiring board having a first surface and a second surface that are in a front and back relationship, and a support plate having a first opening and joined to the first surface of the flexible wiring board; and
a first component and a second component both disposed on the substrate, wherein
the substrate includes
a first region in which the first surface extends along a first direction and a second direction orthogonal to each other,
a second region that is disposed on one side of the first region in the first direction and in which the first surface extends along a third direction orthogonal to the first direction and the second direction, and
a first coupling region that is located between the first region and the second region and is bent such that a support plate side is located inside,
the first component is attached to the first surface in the first region via the first opening, and
the second component is attached to the second region.

2. The electronic component according to claim 1, wherein
the second component is attached to the second surface in the second region.

3. The electronic component according to claim 1, wherein
the support plate has a second opening in the second region, and
the second component is attached to the first surface via the second opening in the second region.

4. The electronic component according to claim 1, wherein
the substrate includes
a third region that is disposed on one side of the first region in the second direction and in which the first surface extends along the third direction, and
a second coupling region that is located between the first region and the third region and is bent such that a support plate side is located inside, and
a third component attached to the third region is provided.

5. The electronic component according to claim 4, wherein
the third component is attached to the second surface in the third region.

6. The electronic component according to claim 4, wherein
the support plate has a third opening in the third region, and
the third component is attached to the first surface via the third opening in the third region.

7. The electronic component according to claim 4, wherein
each of the first component, the second component, and the third component includes a mounting surface attached to the first surface, a lid surface on an opposite side from the mounting surface, a side surface coupling the mounting surface and the lid surface, and a terminal disposed from the mounting surface to the side surface, and
the terminal is electrically coupled to a wiring on the flexible wiring board via a conductive joining material.

8. The electronic component according to claim 3, wherein
a thickness of the support plate in the first coupling region is smaller than a thickness of the support plate in the first region and the second region.

9. The electronic component according to claim 3, wherein
the second opening in the second region is formed from the second region to the first coupling region, and
a length along the second direction of the flexible wiring board in the first coupling region is within a range of a length along the second direction of the second opening in the first coupling region.

10. A sensor module comprising:
a substrate including a flexible wiring board having a first surface and a second surface that are in a front and back relationship, and a support plate having a first opening and joined to the first surface of the flexible wiring board; and
a first sensor device and a second sensor device both disposed on the substrate, wherein
when three axes orthogonal to one another are referred to as an X axis, a Y axis, and a Z axis,
the first sensor device includes a first sensor element and a first package that accommodates the first sensor element and has a surface along the X axis and the Y axis and a thickness along the Z axis, and a direction of the thickness of the first package intersects a mounting surface of the first package attached to the substrate, and
the second sensor device includes a second sensor element and a second package that accommodates the second sensor element and has a surface along the Y axis and the Z axis and a thickness along the X axis, and a direction of the thickness of the second package intersects a mounting surface of the second package attached to the substrate,
the substrate includes
a first region in which the first surface extends along a first direction and a second direction orthogonal to each other,
a second region that is disposed on one side of the first region in the first direction and in which the first surface extends along a third direction orthogonal to the first direction and the second direction, and
a first coupling region that is located between the first region and the second region and is bent such that a support plate side is located inside,
the first sensor device is attached to the first surface in the first region via the first opening, and
the second sensor device is attached to the second region.

11. The sensor module according to claim 10, wherein
the second sensor device is attached to the second surface in the second region.

12. The sensor module according to claim 10, wherein
the support plate has a second opening in the second region, and
the second sensor device is attached to the first surface via the second opening in the second region.

13. The sensor module according to claim 10, wherein
the substrate includes
a third region that is disposed on one side of the first region in the second direction and in which the first surface extends along the third direction, and
a second coupling region that is located between the first region and the third region and is bent such that a support plate side is located inside,
a third sensor device attached to the third region is provided,
the third sensor device includes a third sensor element and a third package that accommodates the third sensor element and has a surface along the X axis and the Z axis and a thickness along the Y axis, and
a direction of the thickness of the third package intersects a mounting surface of the third package attached to the substrate.

14. The sensor module according to claim 13, wherein
the support plate has a third opening in the third region, and
the third sensor device is attached to the first surface via the third opening in the third region.

15. A method for manufacturing an electronic component, the method comprising:
a component attaching step of preparing a flexible wiring board having a first surface and a second surface that are in a front and back relationship, a first component, and a second component, attaching the first component to the first surface of the flexible wiring board, and attaching the second component to the first surface or the second surface;
a substrate forming step of preparing a support plate having a first opening, and forming a substrate by joining the support plate to the first surface of the flexible wiring board such that the first component is disposed in the first opening; and
a bending step of bending the substrate such that a support plate side of a first coupling region between a first region including the first component and a second region including the second component is to be inside.

16. The method for manufacturing the electronic component according to claim 15, wherein
the support plate has a second opening in the second region,
in the component attaching step, the second component is attached to the first surface of the flexible wiring board, and
in the substrate forming step, the support plate is joined to the first surface of the flexible wiring board such that the second component is disposed in the second opening in the second region.

17. The method for manufacturing the electronic component according to claim 15, wherein
in the component attaching step, a third component is attached to the first surface or the second surface of the flexible wiring board, and
in the bending step, bending is performed such that a support plate side of a second coupling region between a third region including the third component and the first region is to be inside.

18. The method for manufacturing the electronic component according to claim 17, wherein
the support plate has a third opening in the third region,
in the component attaching step, the third component is attached to the first surface of the flexible wiring board, and
in the substrate forming step, the support plate is joined to the first surface of the flexible wiring board such that the third component is disposed in the third opening in the third region.

19. The method for manufacturing the electronic component according to claim 17, wherein
when the first surface in the first region extends along a first direction and a second direction orthogonal to each other,
the second region is located on one side of the first region in the first direction,
the third region is located on one side of the first region in the second direction, and
in the bending step, the substrate is bent such that the first surface in the second region and the first surface in the third region extend along a third direction orthogonal to the first direction and the second direction.

20. The method for manufacturing the electronic component according to claim 15, wherein
in the substrate forming step, the flexible wiring board couples regions constituting a plurality of electronic components, a plurality of the support plates are prepared, the plurality of support plates is joined to the flexible wiring board, and then the flexible wiring board is diced into the substrates.
